(19) United States
(12) Patent Application Publication
(10) Pub. No.: US 2007/0175013 A1
(43) Pub. Date: Aug. 2, 2007

(54) Cleanable punching arrangement

(76) Inventor: Uwe Messerschmid, Albershausen (DE)

Correspondence Address: FLYNN THIEL BOUTELL & TANIS, P.C., 2026 RAMBLING ROAD, KALAMAZOO, MI, 49008-1631, US

(21) Appl. No.: 11/649,008

(22) Filed: Jan. 3, 2007

(30) Foreign Application Priority Data
Jan. 27, 2006 (DE) 102006004552.1

(51) Int. Cl. B23P 19/00

(52) U.S. Cl. 29/426.1

(57) ABSTRACT

In a process for cleaning a punching arrangement for punching out and forming a container bottom from a punching strip, a die is removed from its operational position for the purposes of cleaning and subsequently returned to its operating position. The die remains connected to the punching arrangement via a guiding element when removed from its operational position. The die can be withdrawn along the guiding element out of the punching arrangement. Furthermore, a punching arrangement is described in which the cleaning process can be very easily carried out.

### BACKGROUND AND SUMMARY OF THE INVENTION

The present invention relates to a process for cleaning a punching arrangement for punching out and forming a container bottom or a lid out of a punching strip, in which a die is removed from its operational position for the purposes of cleaning and subsequently returned thereto.

The present invention relates further to a punching arrangement for punching out and forming a lid or a container bottom from a punching strip having a die which is mounted to a movable centre sleeve in a releasable way.

Punching installations of this type are used in the industry in a variety of machines for processing material webs. In particular, the punching arrangement can be applied in a machine in which a composite paperboard material in web form is processed to form a beverage container, in particular a paperboard cup or an essentially cylinder-shaped beverage can. In this process, a material cut-out is punched out of the composite paperboard material, fed in the form of a punching strip, said material cut-out being, in the case of beverage containers, usually circular in shape and being formed into a container bottom or lid of the beverage container. For the composite paperboard a material is usually used which is composed of layers of polyethylene, aluminium, and cardboard or paperboard. When the material is being punched out from the punching strip, dust arises which contains small aluminium, paper or polyethylene particles, which can accumulate in deposits on some parts of the arrangement. The parts of the arrangement concerned are mainly the cutting bush and the die of the punching arrangement. After a certain amount of operational time, so much dust can gather on the die and the cutting bush, which dust can also adhere thereto due to the polyethylene particles and the increased temperature in the punching arrangement, that a fault-free punching process can no longer be carried out. The material cut-outs punched out may then be defective and thus cannot be processed. In this case the punching arrangement must be cleaned. The cleaning process must usually be carried out once a day. The cleaning process in the case of the known punching arrangement is very time-consuming. In order for the punching arrangement to be cleaned, the entire installation for producing beverage containers must be stopped and the die must be removed from the punching arrangement. In order to disassemble the die from the movable centre sleeve which executes the punching and forming movements, three screws in the die base must be released, so that the die can be removed from the punching arrangement. When the die is removed, the dust-covered surfaces of the die itself and the cutting bush are cleaned. The die is subsequently re-assembled by means of the three screws. During the re-assembly of the die, the screws of the die may only be lightly tightened in a first phase. A test punch is then required, in which the die is aligned and finds its correct position. In a second step, the screws for fastening the die can be tightened fully and the punching arrangement is then ready for operation. The work steps disassembly, re-assembly and re-alignment require so much time that many other components of the installation cool down to unacceptable levels. It is therefore necessary, after the cleaning process, to initially bring the machine during the start-up up to operational temperature again, during which time sub-standard goods are produced. The entire cleaning time, from the stopping of the installation to the end of the warm-up phase, amounts to approximately 30 minutes and results in a sub-standard production of approximately 5000 beverage containers.

It is an object of the present invention to provide a punching arrangement for the production of beverage containers which is easy to clean, to simplify the process for cleaning such a punching arrangement, and to shorten the cleaning time.

This object has been achieved in accordance with the present invention in that the die remains connected with the punching arrangement via a guiding element when it is removed from its operational position. In the case of the arrangement, the object has been achieved in that a guiding element for guiding the die after it has been released from the centre sleeve is assigned to the die.

The application of the guiding element for the die has the advantage in that the die can be withdrawn from the punching arrangement without losing its position in relation to the other components of the punching arrangement. The die can be pulled a certain distance along the guiding element out of the punching arrangement and be cleaned. After the cleaning process has been completed, the die can be pushed back into its position again along the guiding element. An alignment of the die therefore becomes superfluous.

In this way, the punching arrangement can be cleaned in approximately three minutes, whereby all other components in the installation retain their operational temperature, so that the installation is ready for operation immediately after the cleaning process is completed. The necessary warm-up phase in prior art is omitted so that the large number of sub-standard beverage containers, namely around 5000 per cleaning process, is avoided. In the time saved of approximately 27 minutes, a further 5000 beverage containers can be produced, so that the net amount of beverage containers per day amounts, due to the present invention, to approximately 10,000.

In the embodiment of the present invention it is advantageous that the die is unlocked and subsequently pulled out of the punching arrangement along the guiding element. A locking coupling, connected with the centre sleeve, can be arranged to the guiding element for the die. The locking coupling is so designed that the die, which is pushed back along the guiding element into the punching arrangement again, locks into its position. Furthermore, the guiding element can also comprise a guiding rod, which can be arranged centrally in the centre sleeve.

It is advantageous for a further simplification of the cleaning process that the locking coupling is subjected to a blast of pressurized air and thereby can be opened. After the locking coupling is opened, the die can be pulled axially out of the centre sleeve due to the guiding rod being arranged centrally in the centre sleeve. The die is advantageously pulled approximately 10 centimetres out of the centre sleeve. It is advantageous that a stopper is arranged to the guiding rod, so that the guiding element cannot be completely pulled out of the centre sleeve and also that it cannot accidentally fall out of the punching arrangement. The guiding rod can comprise a guiding groove so that the die cannot be rotated azimuthally to the centre sleeve. Due to the guiding element engaging in the locking coupling, it is ensured that the die automatically reaches its pre-determined operational position when it is pushed back after being cleaned.

### BRIEF DESCRIPTION OF THE DRAWINGS

These and further objects, features and advantages of the present invention will become more readily apparent from the following detailed description thereof when taken in conjunction with the accompanying drawings wherein:

FIG. 1 shows a punching arrangement in its operational position directly before a punching process,

FIG. 2 shows the punching arrangement according to FIG. 1 during a first production step,

FIG. 3 shows the punching arrangement according to FIG. 1 during a second production step,

FIG. 4 shows the punching arrangement according to FIG. 1 during the cleaning process.

### DETAILED DESCRIPTION OF THE DRAWINGS

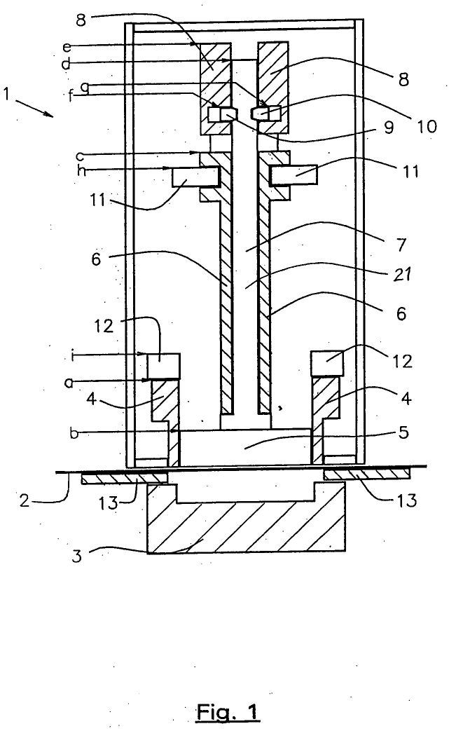

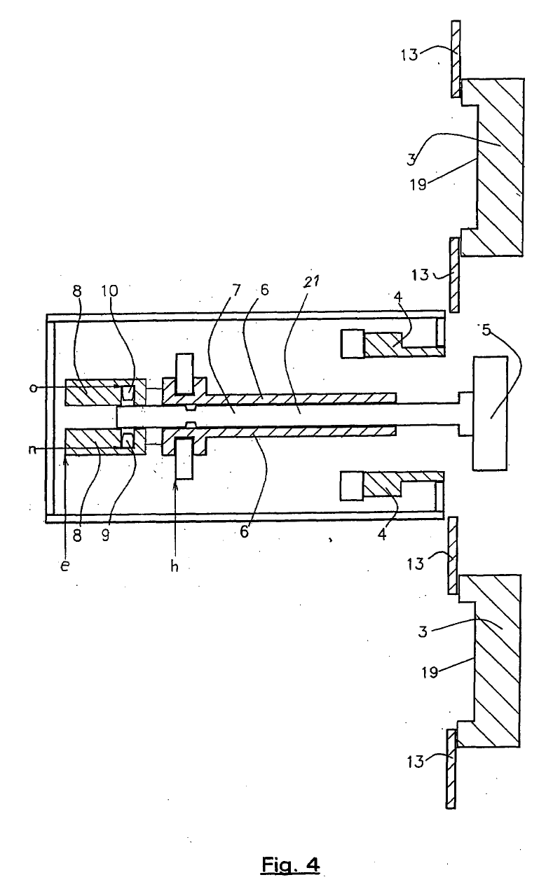

In order to clarify further the advantages of the present invention, the production steps of the punching out and forming process of a container bottom for a beverage container should be first described with the aid of the FIGS. 1 to 3. The cleaning process is subsequently described with the aid of FIG. 4. For reasons of simplicity, only the essential parts of a punching arrangement 1, which are necessary to illustrate the present invention, are shown schematically. As mentioned above, the following description relates only to the container bottom. The descriptions apply just as equally to a lid, which is usually punched out in a second punching arrangement of the above type in an installation for producing beverage cans.

In FIG. 1, the punching arrangement 1 is shown in its operational position directly before a punching process. A punching strip 2 made of paperboard composite material is located between a folding mandrel 3 and the punching arrangement 1. The folding mandrel 3, the drawing bush 13 and the punching arrangement 1 are axially aligned in relation to one another. The cutting bush 4 is located in position a, the die 5 is in position b, the centre sleeve 6 is in position c, the guiding rod 7 is in position d, the locking coupling 8 is in position e, the locking devices 9 and 10 are in positions f and g, the centre sleeve drive 11 is in position h and the cutting bush drive 12 is located at position i. The positions denoted by the letters a to o give the height of the respective component in relation to the punching strip 2 and serve to illustrate the movements of the individual components of the punching arrangement 1.

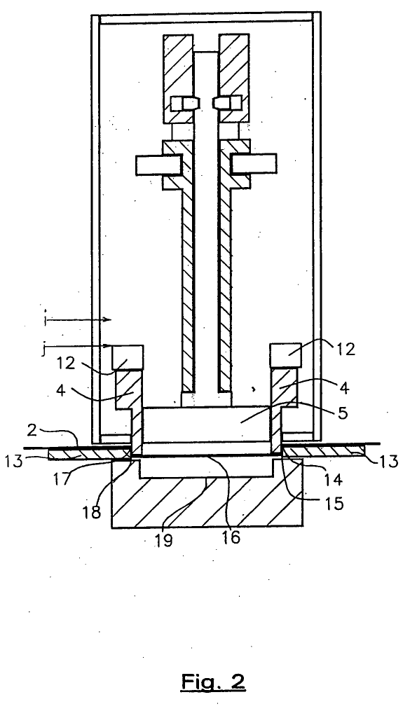

In FIG. 2, the punching out of the circular blank 16 from the punching strip 2 is shown. This is achieved by moving the cutter bush drive 12 from the position i to the position j. In the punching out process, the punching strip 2 is cut by the cutting edge 14 of the drawing bush 13 and by the cutting edge 15 of the cutting bush 4 out of which results the circular blank 16. Friction particles, which resemble dust, occur hereby at the cut edges 17 and 18 of the punching strip and the circular blank 16. The friction particles are deposited above all on the exposed surfaces of the die 5, the cutting bush 4, the drawing bush 13 and the die plate 19, which particles may also partly adhere thereto, as they may contain polyethylene in addition to the paper. After the punching arrangement has been in operation for approximately eight hours, so much dust has accumulated that the circular blank 16 can no longer be cut out properly and without fault. A cleaning process is therefore necessary.

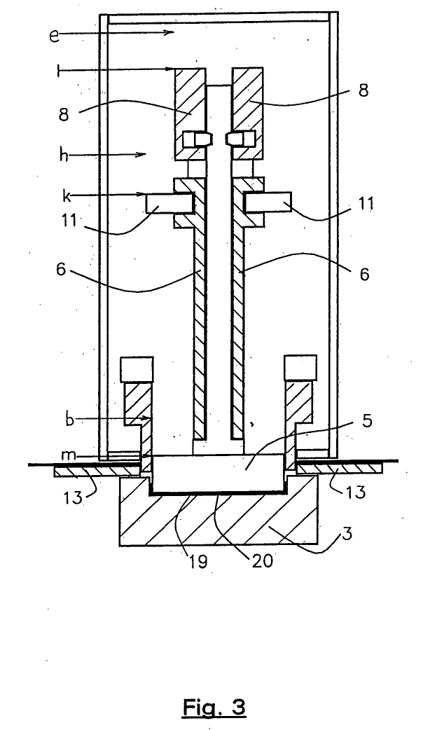

In FIG. 3, the forming of the container bottom 20 from the circular blank 16 after same has been punched out is shown. The die 5 is moved by means of the centre sleeve 6 via the centre sleeve drive 11 inside the drawing bush 13 into the die plate 19 of the folding mandrel 3. The circular blank 16 is hereby driven in front of the die 5 into the die plate 19. This is achieved in that the centre sleeve drive 11 moves from the position h into the position k. The locking coupling 8, arranged at the end of the centre sleeve 6 opposite the die 5, moves in this production step with the centre sleeve drive 11 and changes its position from e to l. The die 5 has moved from its starting position b in FIG. 1, which is also denoted as operational position b in the following, to the position m and has pushed the circular blank 16 into the die plate 19 of the folding mandrel.

Subsequent to these productions steps, the container bottom 20 is formed. In order to disengage the folding mandrel 3 for further production steps, the die 5 is returned from the position m to its operational position b and the cutting bush 4 is returned to its position a. The cutting bush drive 12 moves back to the position i and the centre sleeve drive 11 moves back to the position c. The locking coupling mounted on the centre sleeve 6 moves back accordingly into the position e. The folding mandrel 3 with the finished container bottom 20 is moved away from the punching arrangement 1 and fed to further working stations (not shown) for the production of the beverage container. At the same time, an empty folding mandrel is fed to the punching arrangement and the punching strip 2 is transported a step further. The production steps of punching out and forming of a new container bottom 20 can be repeated.

During operation, approximately 15 metres of punching strip 2 per minute run through the punching arrangement 1, during which time approximately 120 punching processes are carried out in the punching arrangement 1. After eight operating hours the machine parts cutting bush 4, the die 5, the drawing bush 13 and the die plate 19 are covered with dust to such an extent that these components need to be cleaned.

The entire installation is stopped for the cleaning process. There is often a special cleaning programme provided which can be chosen from the control console of the machine control system. As shown in FIG. 4, the folding mandrel 3 and the drawing bush 13 are positioned in such a way that the die 5 of the punching arrangement 1 is freely accessible. The punching arrangement 1 is located in the centre between two folding mandrels 3. The installation is stopped in this position and the locking coupling 8 is unlocked by the machine operator. The unlocking of the locking coupling 8 takes place advantageously pneumatically in that pressurized air is admitted thereto, whereby the locking devices 9 and 10 move into the positions n and o. Due to the unlocking of the locking coupling 8, the connection between the guiding rod 7 and the centre sleeve 6 is suspended and the die 5 can be pulled out of the centre sleeve with the guiding rod 7 by approximately 10 centimetres. The guiding rod 7 forms a guiding element 21, which ensures the guiding of the die 5 in the unlocked state of the locking coupling 8. A stopper can be assigned to the guiding element in a way not shown, which prevents the guiding rod 7 from being pulled completely out of the centre sleeve 6.

In the withdrawn state of the die 5, the surfaces of the die 5 and the now freely accessible surfaces of the cutting bush 4 can be cleaned and freed of dust. After the cleaning process, the guiding rod with the die 5 fastened thereto is pushed back into the centre sleeve 6. The guiding rod 7 is advantageously guided in a non-rotatable way by a guiding groove (also not shown) in the centre sleeve 6. When the guiding rod 7 is completely pushed back into the centre sleeve 6, the locking devices 9 and 10 of the locking coupling 8 are moved back into their positions f and g, so that the die 5 is accordingly fastened again to the centre sleeve 6. In the case of a pneumatic activation of the locking coupling 8, it can be provided that the locking devices 9 and 10 are unlocked by means of the application of pressurized air and pressed back into their starting positions f and g by means of springs. Applying the corresponding embodiments of the locking coupling 8 and/or the guiding rod 7 prevents the locking devices 9 and 10 from being pressed back prematurely to their starting positions f and g. For example, the length of the guiding rod 7 in relation to the distance of the die 5 when pulled out of the punching arrangement is so chosen that the locking devices 9 and 10, during the pulled-out state of the guiding rod 7, are supported on the outer surface of the guiding rod 7 and pressed thereagainst by means of the spring force. As soon as the die 5 is pushed back into its operational position b, the locking devices 9 and 10 engage in the recess on the guiding rod 7. Pressurized air from a time-controlled relais need only act on the locking devices for a short time, for example, two seconds, in order to unlock the guiding rod 7. Locking and engaging follows then automatically.

After the die 5 and the cutting bush 4 have been cleaned, the drawing bush 13 and the die plate 19 are cleaned. After the cleaning process has been completed, the installation can be put into operation again. Because of the very short stoppage for cleaning, almost no sub-standard beverage containers are produced when the installation starts up again.

1. A process for cleaning a punching arrangement for punching out and forming a container bottom or lid from a punching strip, in which a die is removed from its operational position for the purposes of cleaning and is subsequently returned to its operational position, wherein the die, when removed from its operational position, remains connected with the punching arrangement via a guiding element.

2. A process according to claim 1, wherein the die is unlocked and subsequently withdrawn from the punching arrangement along the guiding element.

3. A process according to claim 1, wherein the die is slid along the guiding element after cleaning and returned to the punching arrangement where it engages in its operational position again.

4. A punching arrangement (1) having a die (5) for punching out and forming a lid or a container bottom (20) from a punching strip (2), which die (5) is mounted on a movable centre sleeve in a releasable way, wherein a guiding element (21) for guiding the die (5) after it is released from the centre sleeve (6) is assigned to the die (5).

5. A punching arrangement according to claim 4, wherein a locking coupling (8) connected to the centre sleeve (6) is arranged to the guiding element (21).

6. A punching arrangement according to claim 4, wherein the guiding element (21) comprises a guiding rod (7).

7. A punching arrangement according to claim 6, wherein the guiding rod (7) is arranged in the centre of the centre sleeve (7).
